(19) United States
(12) Patent Application Publication
(10) Pub. No.: US 2013/0155492 A1
(43) Pub. Date: Jun. 20, 2013

(54) METAMATERIALS WITH ENHANCED NONLINEARITY

(71) Applicant: Washington University, St. Louis, MO (US)

(72) Inventors: Jung-Tsung Shen, Olivette, MO (US); Daniel Ironside, St. Louis, MO (US)

(73) Assignee: WASHINGTON UNIVERSITY, St. Louis, MO (US)

(21) Appl. No.: 13/716,531

(22) Filed: Dec. 17, 2012

Related U.S. Application Data
(60) Provisional application No. 61/577,760, filed on Dec. 20, 2011.

(51) Int. Cl. G02F 1/35

(52) U.S. Cl. CPC G02F 1/3501
USPC 359/326; 29/428

(57) ABSTRACT

Embodiments provide metamaterials having an enhanced nonlinear response to light. The metamaterials are artificially manufactured materials having a nonlinear response to light greater than that typically found in naturally occurring materials. A two-dimensional periodic metal-dielectric array can be mathematically mapped as an effective uniform dielectric slab with enhanced optical nonlinearity. The enhanced nonlinearity is controlled by the geometry of the array. Further, the configuration of the array can be applied to form three-dimensional structures having an enhanced nonlinear response to light.

### CROSS-REFERENCE TO RELATED APPLICATION

This application claims the benefit of U.S. Provisional Application No. 61/577,760 filed Dec. 20, 2011, which is incorporated herein in its entirety.

### BACKGROUND

Nonlinear materials give rise to a multitude of optical phenomena that have important applications in technology and fundamental science. One example is wave mixing, in which light of two different frequencies can be added or subtracted through nonlinear optical responses to create light at new frequencies. Wave mixing is an important optical process since it is able to generate light at frequencies that are not available in typical lasers and/or frequencies for which efficient photodetectors are available. Another example is optical bistability, in which the intensity of output light can take two distinct stable values for a given input, creating an optical two-state system. Bistable devices, such as optical logic gates and memory, are important for optical computing, which has the potential for much faster computation speeds than those in current computation devices. Yet another example is self-focusing, in which a light pulse through an optical fiber with suitable nonlinearity can maintain its shape when propagating a long distance in the fiber. Self-focusing is important for long-distance telecommunications.

The degree of optical nonlinearity in a material depends upon the strength of the optical field, and varies across different materials. For a nonlinear material of the Kerr-type, the relative permittivity, ε, is dependent upon the electric field, E, as expressed by ε(E)=εₗ+χ⁽³⁾|E|², where εₗ is the linear relative permittivity of the material and χ⁽³⁾ is the third-order nonlinear coefficient of the material. The nonlinear contribution to optical processes becomes significant when χ⁽³⁾|E|² is of the order of εₗ, which is generally realized with a relatively strong electric field, as the third-order nonlinear coefficient is relatively small in naturally occurring optical materials. Accordingly, intense laser light is typically needed to observer nonlinear optical phenomena, limiting the application of nonlinear optics.

At least some nonlinear optical components utilize nonlinear resonators for switching and modulation. However, a modulation speed and an available fractional bandwidth of known high quality-factor (high-Q) nonlinear resonators are reduced by the relatively large Q values.

### BRIEF DESCRIPTION OF THE DRAWINGS

The embodiments described herein may be better understood by referring to the following description in conjunction with the accompanying drawings.

FIG. 1 is a schematic diagram of a two-dimensional array having an enhanced nonlinear response to light.

FIG. 2 is a unit cell representation of the array shown in FIG. 1.

FIG. 3 is a unit cell representation of an effective uniform dielectric slab.

FIG. 4 is a schematic diagram of a setup that may be used to simulate the array shown in FIG. 1.

FIG. 5 is a graph illustrating transmission of incident light versus a permittivity ratio.

FIG. 6 is a graph illustrating transmission of incident light versus a permittivity ratio.

FIG. 7 is a graph illustrating transmission of incident light versus a length ratio.

FIG. 8 is a graph illustrating transmission of incident light versus a length ratio.

FIG. 9 is a graph illustrating total transmission of light versus a permittivity ratio.

FIG. 10 is a three-dimensional structure that has an enhanced nonlinear response to light.

FIG. 11 is a three-dimensional cube that has an enhanced nonlinear response to light.

FIG. 12 is a flowchart of an exemplary method of assembling a metamaterial having an enhanced nonlinear response to light.

FIG. 13 is a graph of a second harmonic transmission of a grating designed for CuCl.

FIG. 14 shows a graph of a third harmonic transmission of a grating designed for GaAs.

FIG. 15 shows a graph of a bistability curve of a metal-dielectric grating containing Si.

FIG. 16 shows a graph of second harmonic generation of a grating with silver and CuCl.

### DETAILED DESCRIPTION

Embodiments provide metamaterials having an enhanced nonlinear response to light. The metamaterials are artificially manufactured materials having a nonlinear response to light greater than that typically found in naturally occurring materials. A two-dimensional periodic metal-dielectric array can be mathematically mapped as an effective uniform dielectric slab with enhanced optical nonlinearity. The enhanced nonlinearity is controlled by the geometry of the array. Further, the configuration of the array can be applied to form three-dimensional structures having an enhanced nonlinear response to light. Moreover, the metamaterials described herein may operate with a relatively low quality factor, Q, such that they provide a temporal response as short as a few picoseconds.

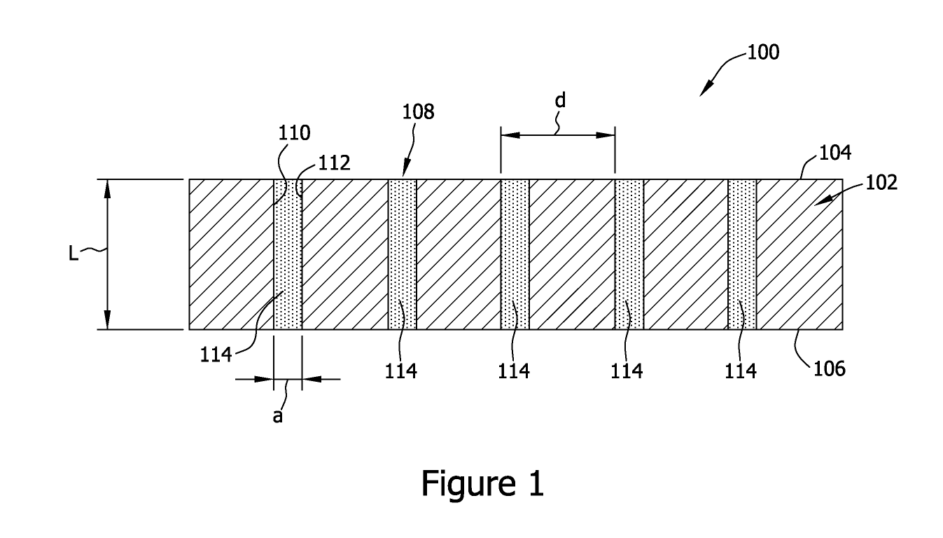

FIG. 1 is a schematic diagram of a two-dimensional array 100 having an enhanced nonlinear response to light. Array 100 includes a film 102 that includes a first surface 104 and an opposite second surface 106. A thickness, L, of film 102 is defined as the distance between first surface 104 and second surface 106.

As shown in FIG. 1, a plurality of slits 108 are defined through film 102 extending from first surface 104 to second surface 106. Slits 108 are each defined by a first edge 110 and an opposite second edge 112. A width, a, of each slit 108 is defined as the distance between first edge 110 and second edge 112. Slits 108 in array 100 have a periodicity, d. Periodicity d is defined as the distance from a first edge 110 of a slit 108 to a first edge 110 of an adjacent slit 108. As shown in FIG. 1, d>a.

Film 102 is composed of a metallic material. For example, film 102 may be composed of gold, silver, aluminum, and/or any other metal that enables array 100 to function as described herein. In the exemplary embodiment, metallic material has a thickness greater than a skin depth of the material. Array 100 further includes a plurality of dielectric elements 114 that are located in slits 108. Specifically, for each slit 108, dielectric element 114 is positioned between first edge 110 and second edge 112 and extends from first surface 104 to second surface 106. Dielectric elements 114 are composed of a nonlinear material having a relative permittivity, ε. Dielectric elements 114 may be composed of, for example, fused silica having a nonlinear index of 3×10⁻¹⁶ cm²/W.

For Kerr-type nonlinear materials, such as dielectric elements 114 the relative permittivity can be expressed as a function of an electric field, E, as ε(E)=εₗ+χ⁽³⁾|E|², where εₗ is the linear relative permittivity of dielectric element 114 and χ⁽³⁾ is the third-order nonlinear coefficient of dielectric element 114.

While in the exemplary embodiment, dielectric element 114 is a Kerr-type nonlinear material that exhibits third order nonlinearity, the systems and methods described herein may also be implemented using Pockels-type nonlinear materials that exhibit second order nonlinearity. For a Pockels-type dielectric element, the relative permittivity can be expressed as ε(E)=εₗ+χ⁽²⁾|E|, where εₗ is the linear relative permittivity of the dielectric element and χ⁽²⁾ is the second-order nonlinear coefficient of the dielectric element.

Generally, the order of magnitude of χ⁽³⁾ in units of centimeters squared per Farad squared (cm²/F²) is 10⁻¹⁶ to 10⁻¹⁴ for glasses, 10⁻¹⁴ to 10⁻¹⁷ for doped glasses, and 10⁻¹⁰ to 10⁻⁸ for organic materials. Accordingly, as χ⁽³⁾ is generally relatively small, the nonlinear component of ε becomes significant when the applied electric field E is relatively large. Accordingly, without a substantially large electric field, the practical application of nonlinear properties of naturally occurring nonlinear materials is fairly limited. However, using the metamaterials described herein, a nonlinear response to light can be generated at a lower electric field, as described herein.

Given the configuration of array 100, there exists a transverse electromagnetic (TEM) mode between slits 108 for incident light having a transverse magnetic (TM) polarization. The TEM mode allows for transmission of light through slits 108 when the periodicity, d, is much smaller than the wavelength of the incident light, λ. Under these conditions, the light squeezes through slits 108, resulting in a significant increase in the field intensity, E, within slits 108. The amplified field intensity causes dielectric elements 114 to experience a larger intensity than the incident field, such light transmitted through silts 108 has a larger nonlinear response. Accordingly, array 100 exhibits an enhanced nonlinear response.

To understand the enhanced nonlinearity of array 100, array 100 can be mathematically mapped to an effective uniform dielectric slab. That is, array 100 responds to light in the same way that an effective uniform dielectric slab would respond. Array 100 is mapped to the effective uniform dielectric slab using a unit cell correspondence, in which potential difference, instantaneous power flow, and energy between two equivalent unit cells are conserved.

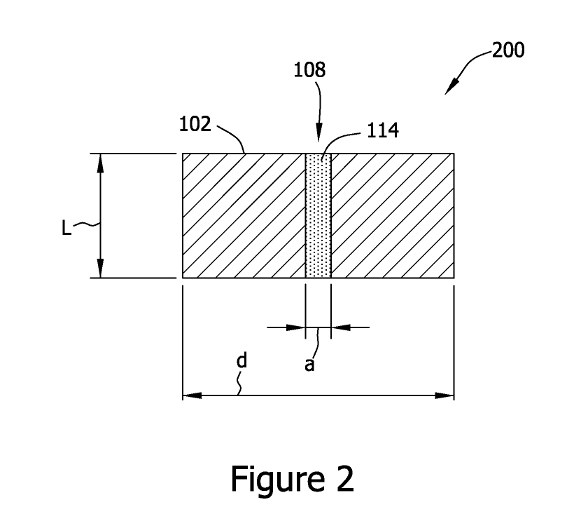

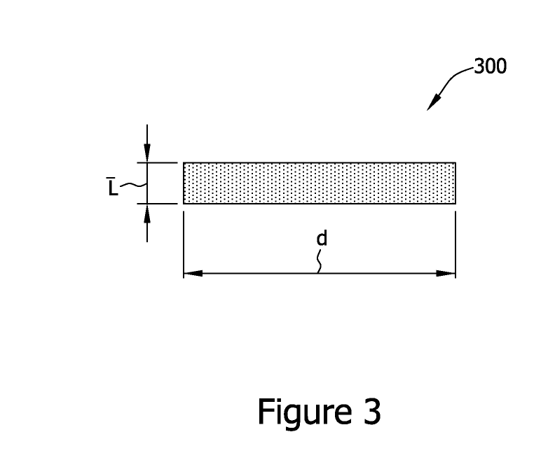

FIG. 2 is a unit cell 200 of array 100. FIG. 3 is a unit cell 300 of a uniform dielectric slab. Unit cell 200 and unit cell 300 each have a width of periodicity d. Unit cell 200 has a thickness L, and unit cell 300 has a thickness L̅. For the purposes of mapping unit cell 200 to unit cell 300, it is assumed that film 102 allows no field penetration (i.e., light only passes through slit 108).

The potential difference over unit cell 200 is a·E, as the field cannot penetrate film 102. The potential difference over unit cell 300 is d·Ē, where E is the electric field in unit cell 200, and Ē is the electric field in unit cell 300. Setting the potential differences of unit cell 200 and unit cell 300 equal to each another, the electric field scaling condition becomes

$$\overline{E} = E ( \frac{a}{d} ) .$$

The instantaneous power flow over unit cell 200 is (E×H)×a , and the instantaneous power flow over unit cell 300 is (Ē× H̅)×d, where H is the magnetic field in unit cell 200, and H̅ is the magnetic field in unit cell 300. Setting the instantaneous power flows of unit cell 200 and unit cell 300 equal to each other, and using

$$\overline{E} = E ( \frac{a}{d} ) ,$$

the magnetic field scaling condition becomes H̅=H.

The energy over unit cell 200 is ½(εE²+μH²)×L×a, where ε is the relative permittivity of dielectric element 114, and μ is the permeability of dielectric element 114. The energy over unit cell 300 is ½( ε̅E̅²+ μ̅H̅²)× L̅×d, where ε̅ is the relative permittivity of the dielectric slab and μ̅ is the permeability of the dielectric slab. Assuming that μ̅=μ=1 and

$$\overline{L} = L ( \frac{a}{d} ) ,$$

and using the scaling conditions above, when the energies of unit cell 200 and unit cell 300 are set equal to each other, the permittivity scaling condition becomes

$$\overline{ɛ} = {ɛ ( \frac{d}{a} )}^{2} .$$

### Accordingly,

$$\overline{ɛ} = {( \frac{d}{a} )}^{2} ( {ɛ}_{l} + {χ}^{( 3 )} {\vert E \vert}^{2} ) = {\overline{ɛ}}_{l} + {χ}^{( 3 )} {\vert \overline{E} \vert}^{2} ,$$

where ε̅ₗ is the linear relative permittivity of unit cell 300, and χ̅⁽³⁾ is the third-order nonlinear coefficient of unit cell 300.

From these equations, it can be determined that

$${\overline{ɛ}}_{l} = {ɛ ( \frac{d}{a} )}^{2} and {\overline{χ}}^{( 3 )} = {{χ}^{( 3 )} ( \frac{d}{a} )}^{4} .$$

Performing similar calculations for a Pockels-type material, it can be determined that

$${\overline{χ}}^{( 2 )} = {{χ}^{( 2 )} ( \frac{d}{a} )}^{3} .$$

Thus, the effective third-order nonlinear coefficient χ̅⁽³⁾ of array 100 is the third-order nonlinear coefficient of dielectric element 114 amplified by a factor of

$${( \frac{d}{a} )}^{4} .$$

As such, by manipulating the ratio of d to a in array 100, the nonlinear properties of dielectric element 114 can be significantly enhanced. For example, when the ratio of d to a is 4, the third-order nonlinear coefficient of array 100 is 256 times the third-order nonlinear coefficient of dielectric element 114.

The permittivity scaling condition is

$$\overline{ɛ} = {ɛ ( \frac{d}{a} )}^{2}$$

asymptotically exact at deep subwavelength scales, λ/d>>1. In some embodiments, to extend this to all subwavelength scales, a general scaled mapping is derived using small refinements to the simple scaled mapping as

$${\overline{ɛ}}_{l} = {{ɛ}_{c} ( \frac{d}{a} )}^{2} {ɛ}_{l} , {\overline{χ}}^{( 2 )} = {{χ}^{( 2 )} ( \frac{d}{a} )}^{3} {χ}^{( 2 )}$$

for second order, and

$${\overline{χ}}^{( 3 )} = {{{χ}_{c}}^{( 3 )} ( \frac{d}{a} )}^{4} {χ}^{( 3 )}$$

for third order, where the dielectric refinements are ε_{c}, χ_{c}⁽²⁾, and χ_{c}⁽³⁾. The values of the dielectric refinements are calculated from the linear solutions of the dielectric grating. The linear dielectric refinement ε_{c} is calculated by matching the linear permittivity of the simple scaled mapping to yield identical transmission coefficients of the metal-dielectric grating, and solved using

$${T}_{grating}^{- 1} = 1 + \frac{{( {( d / a )}^{2} {ɛ}_{l} {ɛ}_{c} - 1 )}^{2}}{4 {( d / a )}^{2} {ɛ}_{l} {ɛ}_{c}} {sin}^{2} ( \frac{2 π}{λ} L ( d / a ) \sqrt{{ɛ}_{l} {ɛ}_{c}} ) .$$

The nonlinear dielectric refinements are calculated by dividing the electric fields within the slit by the fields with corrected linear permittivity as

$${χ}_{c}^{( 2 )} = {( \frac{E}{( d / a ) {E}_{c}} )}^{3}$$

for second order and

$${χ}_{c}^{( 3 )} = {( \frac{E}{( d / a ) {E}_{c}} )}^{4}$$

for third-order nonlinearity. Calculating the refinements yields an exact mapped optical response of the grating. These refinements are generally very small, on the order of 1 percent, and produce the same order of magnitude enhancement for nonlinear materials. When ε_{c}is small, χ_{c}⁽²⁾ and χ_{c}⁽³⁾ are approximately 1. By calculating the refinements, a general scaled mapping is produced with full accuracy over all subwavelength scales.

Notably, for a given value of d/a, array 100 will not exhibit an enhanced nonlinear response in the transmission direction (i.e. through array 100) for all frequencies of incident light. Specifically, at certain frequencies, the transmission of light through array 100 is relatively small, and most of the incident light is reflected by array 100. At such frequencies, array 100 will not exhibit an enhanced nonlinear response. Accordingly, the non-linear response of array 100 is dependent at least in part on the frequency of the incident light. In the exemplary embodiment, the frequency of the incident light is 1.55 microns. Alternatively, incident light may have any frequency that enables array 100 to function as described herein.

To demonstrate the enhanced nonlinear response of array 100, light transmission through array 100 and the effective dielectric slab was simulated. The first simulation demonstrated the mapping in wave mixing transmission, specifically third harmonic generation, in which a single frequency generates new light at three times the incident frequency through frequency summing within the nonlinear material. This was simulated over many incident intensities. The second simulation demonstrated variation in the transmission of third harmonic generation over a range of film thicknesses, while keeping a constant incident intensity. The third simulation demonstrated the mapping in optical bistability. From the results of each simulation, the robustness of the mapping between array 100 and the effective dielectric slab was demonstrated for different film thicknesses, intensities, and wavelengths.

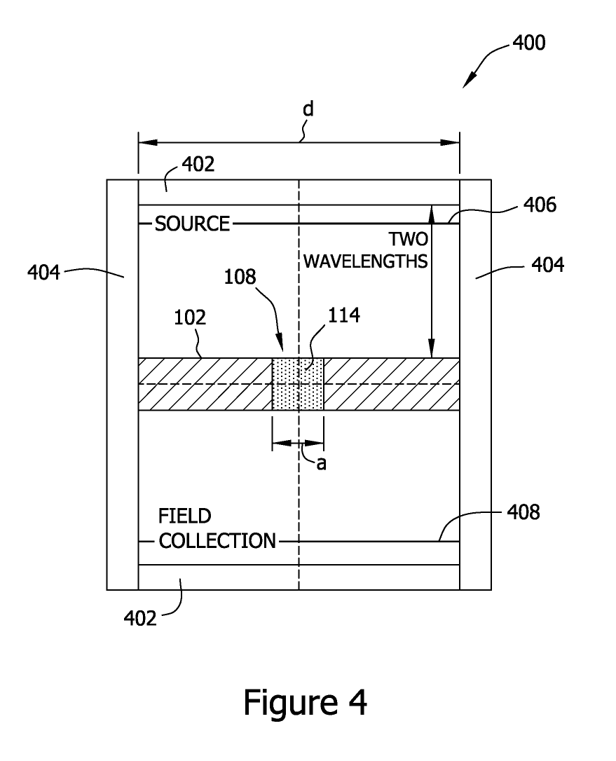

FIG. 4 is a schematic diagram of a setup 400 that was used to perform the simulations for array 100. The periodic system geometry and material definitions were defined at the center of the computational domain, and film 102 ran along the center of the horizontal axis. The width of the computational domain was one full periodicity, d, of the periodic system geometry, with slit 108 and dielectric element 114 centered within film 102. Since the computational domain was symmetric about the vertical axis, a symmetry condition was applied along that axis to reduce computational work by half.

To eliminate reflections at the top and bottom of the computational domain, PML (perfectly-match-layers) 402, near-perfect absorbers of electromagnetic waves, were applied at the top and bottom boundary ends of the computational domain. A thickness of PMLs 402 was adjusted to one-half of the incident source wavelength, λ. A periodic boundary condition 404 was applied to a left edge and a right edge of the computational domain, although all simulations were performed with light at normal incidence to the film 102.

A plane-wave source 406 was used to generate light at a single wavelength, λ, and intensity, and was located just below the top PML 402. The distance between source 406 and the film 102 was two wavelengths. The electric and magnetic field data was collected at a data collection point 408 just above the bottom PML 402. The distance between data collection point 408 and film 102 was also two wavelengths. In total, the length of the computational domain was five wavelengths plus the film thickness, L. A similar setup was used for the uniform dielectric slab, except that only one spatial dimension was used, due to the uniformity of the slab across the horizontal axis. This reduced the computational time of the effective slab results.

The first simulation of the mapping between array 100 and the effective dielectric slab demonstrated the transmission of incident and third harmonic light over a range of intensities at normal incidence to film 102. Since the index of refraction, n, of nonlinear optical materials is intensity dependent, the transmission of both the first and third harmonic frequency was expected to vary with intensity. In this simulation, array 100 had the following parameters: λ=12, d/a=4, nₒ=1.5, a=0.1, λ/d=30, L=35.2, and χ⁽³⁾=3.9×10⁻⁵, where nₒ is the index of refraction of dielectric element 114 (note these are in scale invariant units). Using the mapping from the above equations, the effective slab had the following parameters: λ=12, ε̅ₗ=36, L̅=8.8, and χ̅⁽³⁾=0.01.

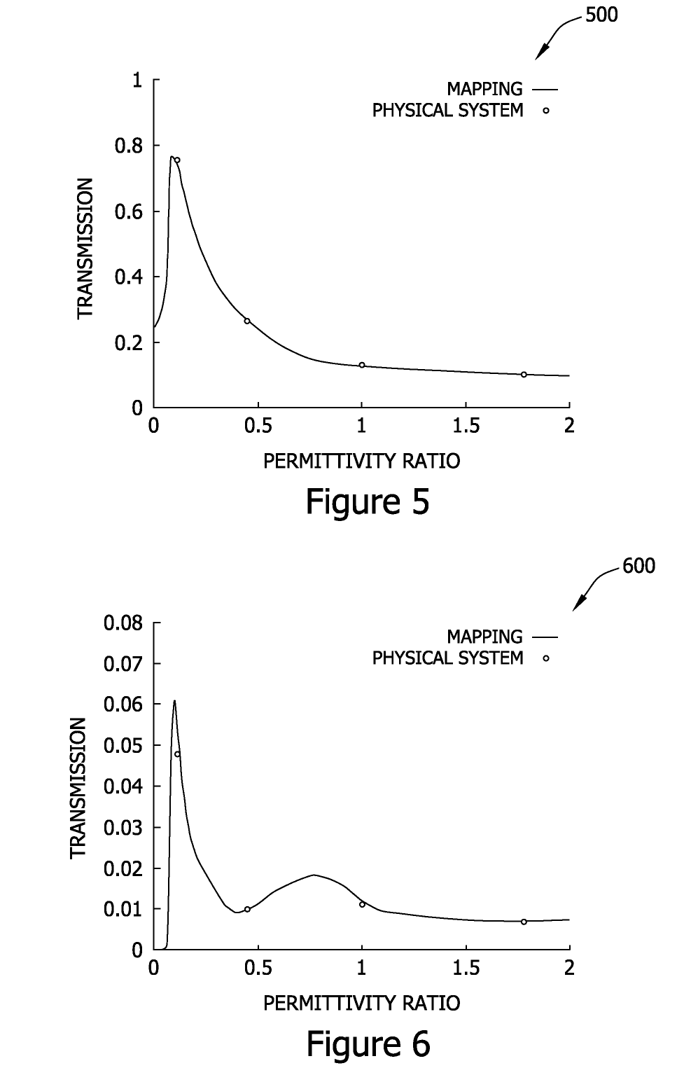

FIG. 5 is a graph 500 illustrating transmission of incident light versus a permittivity ratio. FIG. 6 is a graph 600 illustrating transmission of third harmonic light versus a permittivity ratio. The transmission of the incident and third harmonic light was quantified using transmission coefficients defined as follows,

$${T}_{ω} = \frac{{\vert {E}_{3 ω} \vert}^{2}}{{\vert {E}_{0} \vert}^{2}}$$

for the incident frequency, and

$${T}_{3 ω} = \frac{{\vert {E}_{3 ω} \vert}^{2}}{{\vert {E}_{0} \vert}^{2}}$$

for the third harmonic frequency. For graphs 500 and 600, the points represent the calculated transmission coefficients for array 100, and the line represents the calculated transmission coefficients or the effective dielectric slab. The transmission coefficients were plotted versus the permittivity ratio,

$$\frac{{χ}^{( 3 )} {\vert {E}_{0} \vert}^{2}}{{ɛ}_{l}} ,$$

which expresses the magnitude of the nonlinear part of the total permittivity χ⁽³⁾|E₀|², over the linear part, εₗ. Accordingly, the permittivity ratio varies linearly with incident intensity |E₀|².

Graphs 500 and 600 demonstrate significant variation in transmission with incident intensity. The transmission at the incident and third harmonic frequencies increases as the intensity is increased until 0.14 permittivity ratio is reached, where both frequencies have a maximum transmission of 0.75 and 0.06 respectively. Past 0.14, the transmission coefficients decrease. At 0.40, however, the transmission of third harmonic increases once again, whereas the transmission of incident light continues to decrease.

For both the incident and third harmonic light, the transmission of array 100 substantially agrees with the mapping to the transmission of the effective dielectric slab. Slight differences in the final calculations are a result of the fundamental assumption that array 100 experiences deep subwavelength resonance. For larger λ/d, this error would be reduced. Thus, the first simulation establishes that array 100 acts as a uniform dielectric slab with an index of refraction of 6 and nonlinear index of 0.01, which results in an overall increase of 4 in the index of refraction and an increase of 256 in the third-order nonlinear coefficient of dielectric element 114.

The second simulation of the mapping between array 100 and the effective dielectric slab demonstrated the transmission of the incident and third harmonic light over a range of film thicknesses L, while keeping the field intensity fixed at a normal incidence to film 102. The transmission at both the incident and third harmonic frequencies was expected to vary with film thickness, as wave mixing is very sensitive to variations in film thickness variation. In this simulation, array 100 had the following parameters: λ=16, d/a=8, nₒ=1.5, a=0.1, |E₀|=200, λ/d=20, L₀=32/3, and χ⁽³⁾=2.44×10⁻⁶ (note these are in scale invariant units). Using the mapping from the above equations, the effective slab had the following parameters: λ=16, ε̅ₗ=144, L̅₀=4/3, and χ̅⁽³⁾=0.01.

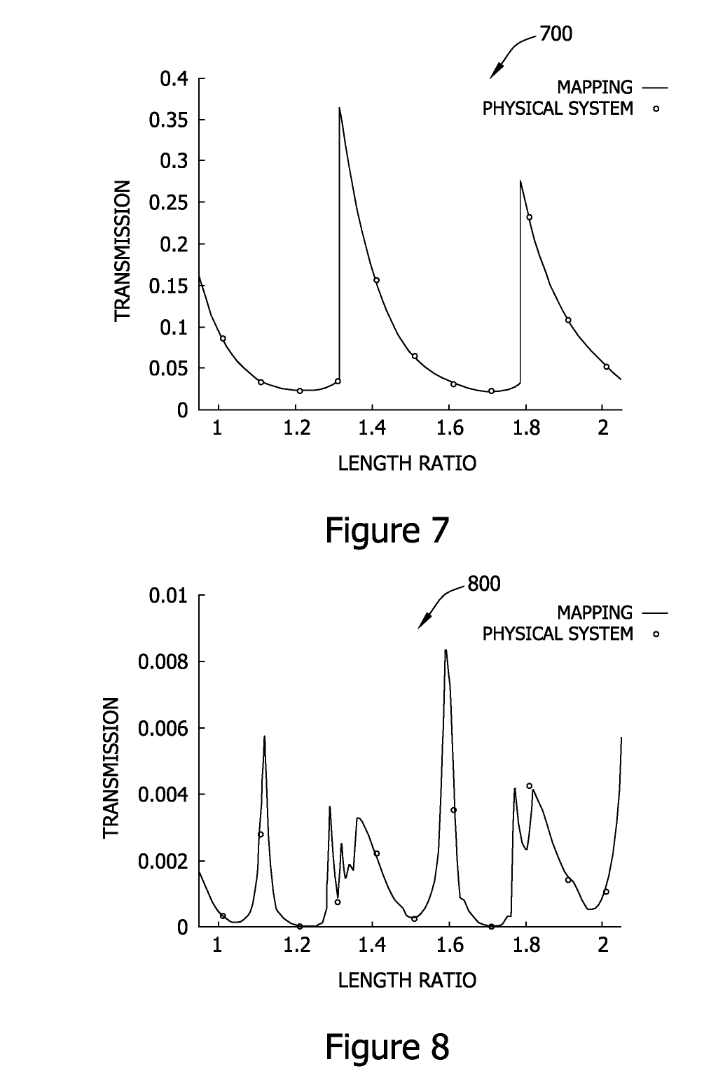

FIG. 7 is a graph 700 illustrating transmission of incident light versus a length ratio. FIG. 8 is a graph 800 illustrating transmission of third harmonic light versus a length ratio. The transmission of the incident and third harmonic light were quantified using transmission coefficients defined as in the first simulation. For graphs 700 and 800, the points represent the calculated transmission coefficients for array 100, and the line represents the calculated transmission coefficients of the effective dielectric slab. The transmission coefficients were plotted versus length ratio, L/L₀, which expresses the film thickness L over the defined film thickness L₀.

Graphs 700 and 800 both display a multitude of nonlinear optical effects with film thickness. The transmission of the incident and third harmonic frequencies are periodic, with a transmission periodicity of 0.45 in length ratio. The transmission at the incident frequency exhibits bistability through discrete jumps at length ratios of 1.3 and 1.8. Further simulation near these length ratios would likely yield a second stable transmission branch. The transmission at the third harmonic frequency shows a much more complicated response to film thickness than at the incident frequency. At length ratios of 1.1 and 1.6, transmission sharply peaks, whereas the corresponding transmission at the incident frequency is near minimum. Two smaller regions of increased third harmonic generation occur at length ratios from 1.3-1.4 and 1.75-1.85.

As in the first simulation, for both the incident and third harmonic light, the transmission of the array 100 substantially agrees with the mapping to the transmission of the effective dielectric slab. Slight differences in the final calculations are a result of the fundamental assumption that array 100 experiences deep subwavelength resonance. For larger λ/d, this error would be reduced. Thus, the second simulation establishes that array 100 acts as a uniform dielectric slab with an index of refraction of 12 and nonlinear index of 0.01, which results in an overall increase of 8 in the index of refraction and an increase of 4096 in the third-order nonlinear coefficient of dielectric element 114.

The third simulation of the mapping between array 100 and the effective dielectric slab demonstrated transmission exhibiting bistability over a range of intensities at normal incidence to film 102. Both array 100 and the effective dielectric slab were expected to display two distinct regions of stable transmission. In this simulation, array 100 had the following parameters: λ=8, d/a=4, nₒ=1.5, a=0.1, λ/d=20, L=64/3, and χ⁽³⁾=3.9×10⁻⁵ (note these are in scale invariant units). Using the mapping from the above equations, the effective slab had the following parameters: λ=8, ε̅ₗ=36, L̅=16/3, and χ̅⁽³⁾=0.01.

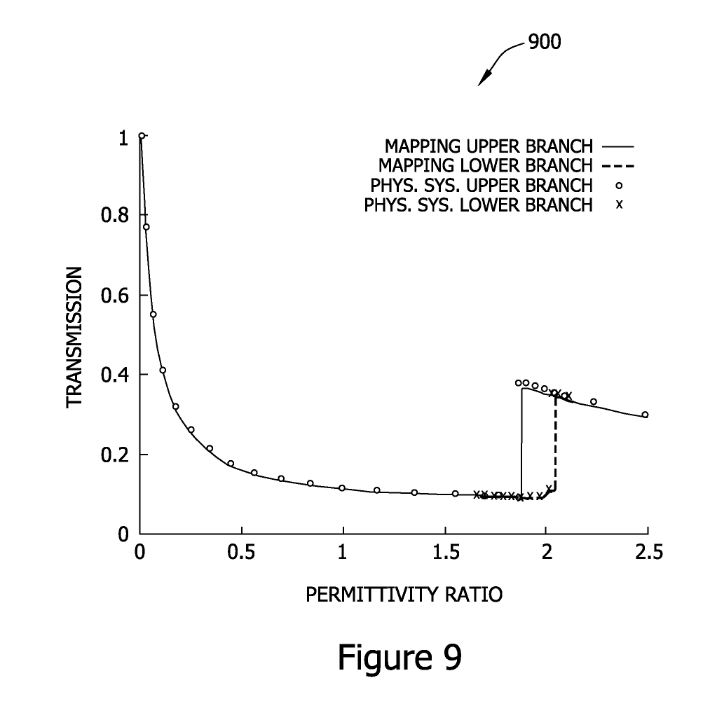

FIG. 9 is a graph 900 illustrating total transmission of light versus the permittivity ratio. The total transmission was quantified using the transmission coefficient, defined as follows in Equation (1):

$${T}_{TOTAL} = \frac{Σ {\vert {E}_{i \times ω} \vert}^{2}}{{\vert {E}_{0} \vert}^{2}} . \qquad ( 1 )$$

To calculate the upper branch of the bistability curve, the intensity of the plane-wave source increased from zero to a steady-state value. This is essentially the same as the previous two simulations, except that there was a slower rise in the steady-state intensity. To calculate the upper branch, a plane-wave source at a steady-state intensity was raised to twice its value using a temporal Gaussian pulse with the peak intensity occurring at the frequency of interest. Using this source, the temporal Gaussian pulse pushed film 102 into a higher-intensity region of single-valued transmission beyond the bistable region. Through the pulse decay, the film fell back into the region of bistability at a steady-state intensity of interest. However, having “remembered” coming from a region of higher intensity, through nonlinear optical processes, the transmission jumped down to the lower branch. Using both sources, the lower and upper branches of bistability were successfully demonstrated.

In graph 900, the points represent the calculated total transmission of the upper branch of array 100 using the single plane-wave source, while the crosses represent the calculated total transmission of the lower branch of array 100 using the dual plane-wave, Gaussian pulsed source. The solid line represents the calculated total transmission of the upper branch of the effective dielectric slab, and the dashed line represents the calculated total transmission of the lower branch of the effective dielectric slab.

In graph 900, the total transmission is single-valued for permittivity ratios from 0 to 1.8. This is confirmed for both the single plane-wave and the dual plane-wave, Gaussian pulsed source, as both resulted in the same total transmission response. At 1.85, the total transmission jumps from 0.10 to 0.40 when the intensity is raised from zero, hence marking the beginning of the upper branch. However, when the intensity is increased past 2.10 and lowered back to 1.85, the total transmission does not jump, hence marking the beginning of the lower branch. At 2.10, the total transmission of the lower branch jumps from 0.15 to 0.35. Past 2.10, the total transmission becomes single-valued again, as confirmed for both the single plane-wave and the dual plane-wave, Gaussian pulsed source, as both resulted in the same total transmission response. Given these properties, the bistability region is referred to as clockwise, as the intensity profile follows a clockwise path to produce a full bistability curve.

The total transmission of array 100 agrees with the mapping to the total transmission of the effective dielectric slab. Slight differences in the final calculations are a result of the fundamental assumption that array 100 experiences deep subwavelength resonance. For larger λ/d, this error would be reduced. Thus, the third simulation establishes that array 100 acts as a uniform dielectric slab with an index of refraction of 6 and nonlinear index of 0.01, which results in an overall increase of 4 in the index of refraction and an increase of 256 in the third-order nonlinear coefficient of dielectric element 114.

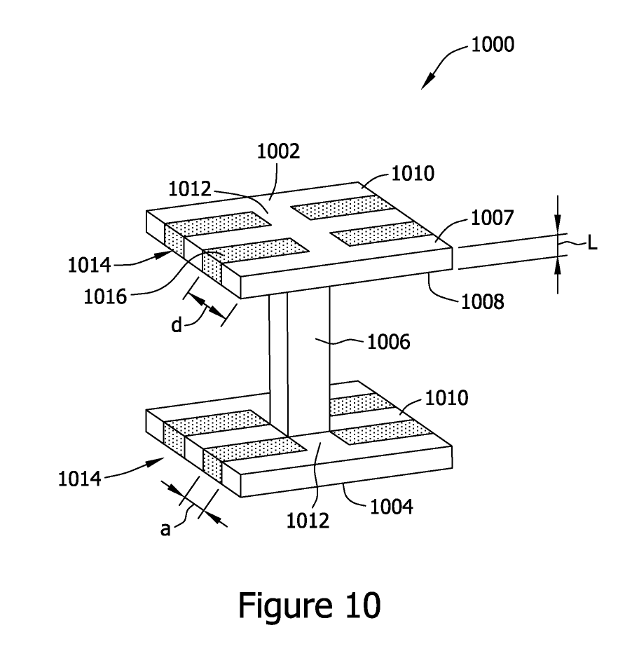

FIG. 10 is a three-dimensional structure 1000 that has an enhanced nonlinear response to light. Structure 1000 includes a first plate 1002 and an opposite second plate 1004 that are coupled to one another by a shaft 1006. First plate 1002 and second plate 1004 are substantially parallel to one another, and shaft 1006 is substantially orthogonal to plates 1002 and 1004. Plates 1002 and 1004 each have a first surface 1007, an opposite second surface 1008, and a thickness L. Plates 1002 and 1004 each include a plurality of substantially parallel arms 1010 extending from a crossbeam 1012. A plurality of slits 1014 are formed between arms 1010 and extending from first surface 1007 to second surface 1008.

In the embodiment shown in FIG. 10, plates 1002 and 1004 each include six arms 1010 and four slits 1014. However, plates 1002 and 1004 may include any number of arms 1010 and/or slits 1014 that enable structure 1000 to function as described herein. Similar to slits 108, slits 1014 have a width, a, and a periodicity, d. In structure 1000, each slit 1014 includes a dielectric element 1016 positioned in slit 1014.

Similar to film 102, plates 1002 and 1004 are composed of a metallic material. For example, plates 1002 and 1004 may be composed of silver, gold, aluminum, and/or any other suitable material having a thickness greater than a skin depth of the material. Dielectric elements 1016 may be composed of fused silica having a nonlinear index of 3×10⁻¹⁶ cm²/W. Plates 1002 and 1004 and dielectric elements 1016 exhibit an enhanced nonlinear response to light, similar to film 102 and dielectric elements 114. Accordingly, similar to array 100, the ratio of d to a can be manipulated in structure 1000 to alter the nonlinear response of structure 1000, similar to array 100.

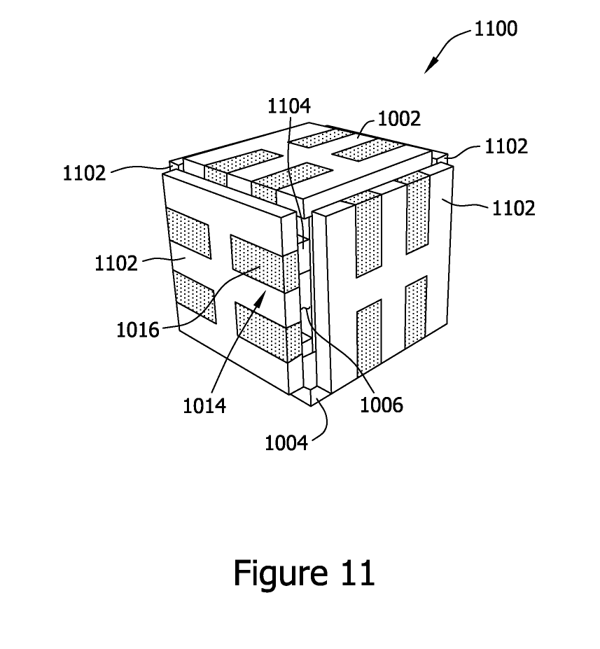

FIG. 11 is a three-dimensional cube 1100 having an enhanced nonlinear response to light. Cube 1100 may be formed by coupling additional plates 1102 to structure 1000, such that additional plates 1102 are substantially orthogonal to plates 1002 and 1004. Accordingly, first plate 1002, second plate 1004, and additional plates 1102 form the six faces of cube 1100.

Additional plates 1102 are substantially similar to plates 1002 and 1004 of structure 1000. That is, additional plates 1102 include dielectric elements 1016 positioned within slits 1014 in plates 1102. In the embodiment shown in FIG. 11, each additional plate 1102 is coupled to shaft 1006 by a member 1104. Alternatively, additional plates 1102 are coupled to structure 1000 by any means that enable cube 1100 to function as described herein. As the six faces of cube 1100 each include slits 1014 and dielectric elements 1016, to generate an enhanced nonlinear response, light can be transmitted towards cube 1100 from a variety of directions and/or angles.

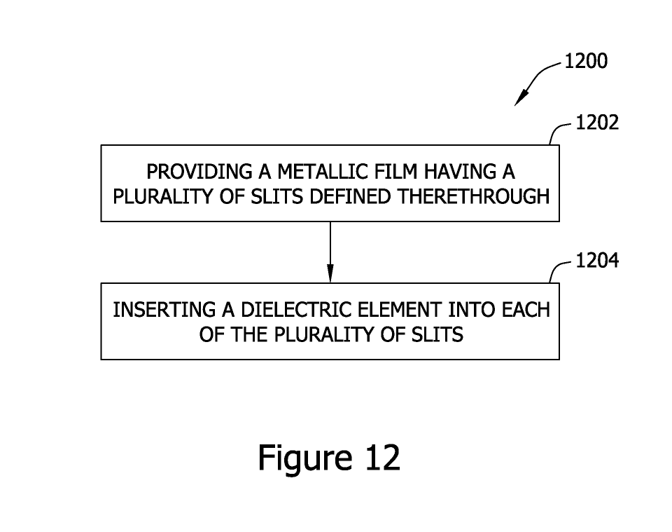

FIG. 12 is a flowchart of an exemplary method 1200 of assembling a metamaterial having an enhanced nonlinear response to light, such as array 100, structure 1000, and/or cube 1100. Method 1200 includes providing 1202 a metallic film having a plurality of slits defined therethrough, such as metallic film 102 and slits 108. The slits in the metallic film have a width a and a periodicity d. A plurality of dielectric elements, such as dielectric elements 114 are inserted 1204 into the slits. A relationship exists between a and d such that the metamaterial formed from the metallic film and the dielectric elements exhibits an enhanced nonlinear response to light that is transmitted through the slits in the metamaterial.

Validations

Rigorous numerical calculations of the far-field transmission for both the metal-dielectric grating and the general scaled mapping were performed. The electrodynamic calculations were processed using a finite-difference time-domain (FDTD) numerical method. The simulation used in all cases was MEEP. These examples demonstrate the enhancement of the grating and the robustness of the general scaled mapping through fundamental nonlinear optical phenomena, specifically harmonic generation in second-order and third-order nonlinear materials, and optical bistability. Reference slabs containing the nonlinear material within the grating were plotted to show the enhanced response of the grating. From the results of each case, the accuracy of the scaled mapping and the many orders of magnitude of enhancement of the grating for different grating thicknesses, periodicities, and intensities were established. Although the grating produces an enhancement for any suitable wavelength, the examples herein utilize the mid-infrared region of light at approximately 10.6 μm.

The first example is the enhancement of harmonic generation. For second-order non-linear materials, a harmonic at twice the input frequency is formed, and for third-order material, a harmonic at three times the input frequency is formed. Other higher harmonics are formed; however, these are much smaller compared to the second or third harmonics. To demonstrate second harmonic generation, we chose cuprous chloride (CuCl) as the second-order dielectric in the grating. At 10.6 μm, CuCl is assumed to have a linear permittivity εₗ=4 and a second-order nonlinearity χ⁽²⁾=6.7 pm/V. For the grating to be subwavelength, the grating periodicity d=1.178 μm and the slit width a=0.147 μm. The film thickness L=10.6 μm for the grating to be near resonance. From the general scaled mapping, the grating acts as a homogeneous dielectric slab with enhanced linear permittivity of ε̅ₗ=258 and enhanced second order non-linearity χ̅⁽²⁾=3444 μm/V at a slab thickness L̅=1.325 μm. In particular, CuCl experiences an enhancement of 64.5 in linear relative permittivity and 514 in second-order susceptibility atop of its naturally occurring constituents.

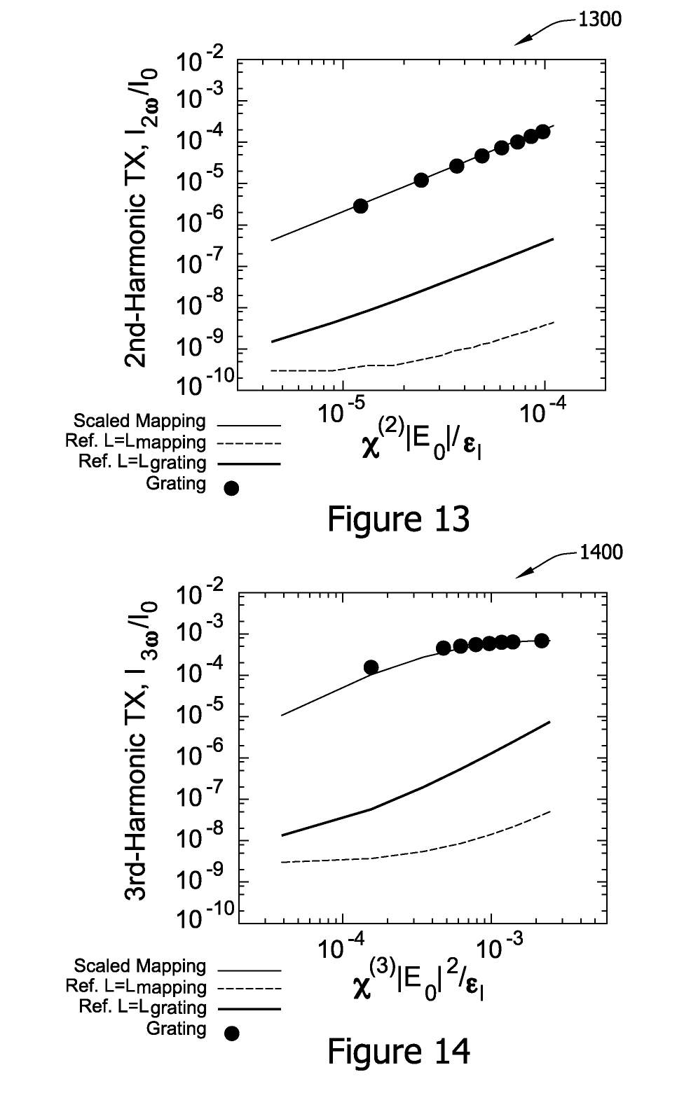

FIG. 13 shows a graph 1300 of the second harmonic transmission of the grating designed for CuCl and the homogeneous dielectric slab from the general scaled mapping for several input field strengths, E₀. The input field strength is presented as a ratio defined as

$$\frac{{χ}^{( 2 )} \vert {E}_{0} \vert}{{ɛ}_{l}}$$

for second order materials. This ratio scales the magnitude of the nonlinear part of the permittivity over the linear permittivity. When the ratio is less than one, the linear part of the permittivity dominates, whereas when the ratio is greater than one, the nonlinear part dominates. For all input fields, general scaled mapping fits extremely well with the metal-dielectric grating. This result confirms the scaled mapping analysis for gratings with second-order materials. Also, this result establishes the general scaled mapping as a predictive model for second harmonic generation in metal-dielectric gratings.

In addition, the nonlinear optical response of several uniform slabs containing CuCl at the same field inputs was calculated to verify the enhancement of the grating. To best illustrate the enhancement from the grating, three different film thicknesses were compared: when reference thickness is equal to the grating thickness, the mapped thickness, and on resonance. For the reference slab, the thickness of the grating and resonance condition are equivalent. For the field strengths used in FIG. 13, the ratio is relatively small. Under the low field input conditions, the second harmonic generation in both systems are in their beginning stages, where conversion efficiency is small. This is a good region to compare the optical response of the grating against the reference slab since this avoids areas of harmonic saturation. Because the conversion to second harmonic generation is linear at low field strength, greater than two orders of magnitude enhancement is clearly evident, and upholds the general scaled mapping prediction that the grating designed generates an enhancement of 514.

In demonstration of third harmonic generation, we chose gallium arsenide (GaAs) as the third-order dielectric in the grating. At 10.6 μm, GaAs is assumed to have a linear permittivity εₗ=10.13 and a third-order nonlinearity χ⁽³⁾=0.120 cm³/erg. For the grating to be subwavelength, the grating periodicity d=0.8 μm and the slit width a=0.1 μm. The film thickness L=3.352 μm for the grating to be near resonance. From the general scaled mapping, the grating acts as a homogeneous dielectric slab with enhanced linear permittivity of ε̅ₗ=644 and enhanced third order non-linearity χ̅⁽³⁾=491.5*10⁻¹⁰ cm³/erg at a slab thickness L̅=0.419 ρm. In particular, GaAs experiences an enhancement of 64.4 in linear relative permittivity and 4096 in third-order susceptibility atop of its naturally occurring constituents.

FIG. 14 shows a graph 1400 of the third harmonic transmission of the grating designed for GaAs and the homogeneous dielectric slab from the general scaled mapping for several input field strength. The input field strength is presented as a ratio defined as

$$\frac{{χ}^{( 3 )} {\vert {E}_{0} \vert}^{2}}{{ɛ}_{l}}$$

for third-order materials. For all input fields, the general scaled mapping fits the metal-dielectric grating. This result confirms the scaled mapping analysis for gratings with third-order materials. Also, this result establishes the general scaled mapping as a predictive model for third harmonic generation in metal-dielectric gratings.

In addition the nonlinear optical response of several uniform slabs containing GaAs at the same field inputs was calculated to verify the enhancement of the grating. The same reference slab technique used in the previous validation was used. Also, for the reference slab, the thickness of the grating and resonance condition are equivalent. For the field strengths used in FIG. 14, the ratio is very small. For the smallest ratios shown, the third harmonic generation in both systems is in their beginning stages, where conversion efficiency is small. Because the conversion to third harmonic generation is linear at these low field strengths, three orders of magnitude enhancement is clearly evident, and upholds the general scaled mapping prediction that the grating designed generates an enhancement of 4096. For the larger ratios shown, the grating appears to plateau. This is a result of large modification of the total permittivity such that the transmission of the fundamental frequency is pushed off resonance. If the third harmonic efficiency, defined as I_{3ω}/I_{ω}, was shown, harmonic conversion would increase linearly, and thus, demonstrate the orders of magnitude enhancement against the reference slabs at these larger ratios.

The second validation is the enhancement of far-field optical bistability. For certain input field intensities, a nonlinear material can generate two distinct, stable output intensities, this is known as the bistability region. The output with the greater transmittance is the upper curve, whereas the lower transmittance is the lower curve. For counterclockwise bistability, the lower curve is reached when driven from intensities lower than the bistability region. Conversely, the upper curve is reached when driven from intensities higher than the bistability region. Because of this, the calculation of both branches of bistability requires added computation finesse. Discrete jumps in transmittance occur when passing through the bistability region from either high or low single-state intensities. These discrete jumps characterize the bistability region. In addition, optical bistability only occurs for specific film thicknesses in third-order nonlinear materials.

To demonstrate bistability, silicon (Si) was chosen as the third-order dielectric in the grating. At 10.6 μm, Si is assumed to have a linear permittivity εₗ=12.094 and a third-order nonlinearity χ⁽³⁾=0.060*10⁻¹⁰ cm³/erg. For the grating to be subwavelength, the grating periodicity d=0.884 μm and the slit width a=0.221 μm such that d/a=4. Because bistability occurs at a specific film thickness, the film thickness L=4.24 μm for the grating. At this film thickness, bistability occurs for the metal-dielectric grating. From the general scaled mapping, the grating acts as a homogeneous dielectric slab with enhanced linear permittivity of ε̅ₗ=194.75 and enhanced third order non-linearity χ̅⁽³⁾=15.36*10⁻¹⁰ cm³/erg at a slab thickness L̅=1.06 μm. In particular, Si experiences an enhancement of 16.1 in linear relative permittivity and 256 in third-order susceptibility atop of its naturally occurring constituents.

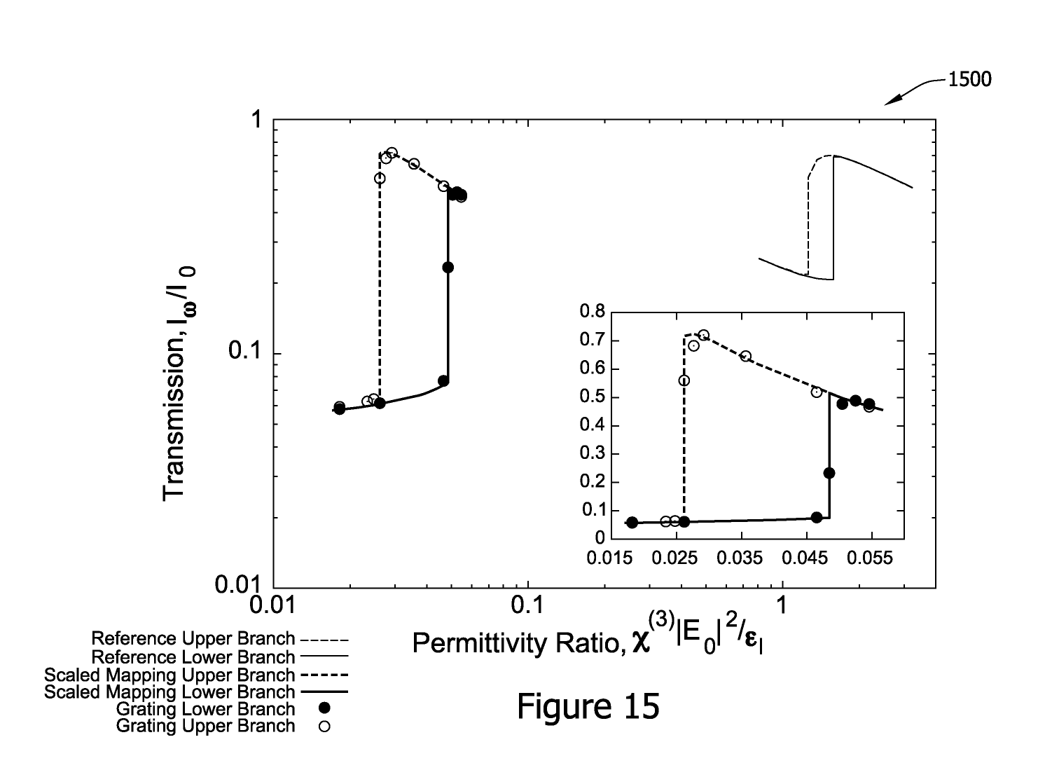

FIG. 15 shows a graph 1500 of the bistability curve of the metal-dielectric grating containing Si and the homogeneous dielectric slab from the general scaled mapping for several input field strengths. For all input fields, the general scaled mapping fits with the metal-dielectric grating. The scaled mapping not only predicts the correct bistable branch transmissions, but also the specific input field intensities at which the bistability region occurs, which is important in the measurement and design of bistability in devices utilizing the phenomena. This result confirms the scaled mapping analysis for gratings with third-order materials in bistability. Also, this result establishes the general scaled mapping as a predictive model for bistability in metal-dielectric gratings.

In addition, the bistability of a uniform slab containing Si at the same field inputs was calculated to verify the enhancement of the grating. To be consistent, the reference slab thickness was chosen to be near the first onset of bistability to match the conditions of the grating. In FIG. 15, the metal-dielectric grating shows bistability at much lower intensities relative to the reference slab. In particular, the bistability region of the grating occurs two orders of magnitude sooner than the reference slab. This result upholds the general scaled mapping prediction that the grating designed generates an enhancement of 256. For fixed d/a, the intensities in bistability region of the grating can be lowered with small increases in film thickness, to further lower its onset. Also, increasing d/a would further lower the onset of bistability. This result is crucial for low-powered devices utilizing optical computation.

The last validation is the enhancement of far-field second harmonic generation gratings containing a lossy metal. To demonstrate this, silver was chosen for the metal gratings. For consistency with the previous validations, the same second-order nonlinear material, cuprous chloride (CuCl) at 10.6 μm, was used. Designing the grating to be subwavelength, the grating periodicity d=5.3 μm and the slit width a=1.325 μm, such that d/a=4. The film thickness L=2.49 μm for the grating to be near resonance. Since the scaled mapping does not involve lossy metals, no scaled mapping is demonstrated herein. However, using it as a guide for the level of enhancement, it is expected that two-orders of magnitude of enhancement should be observed for the chosen parameters.

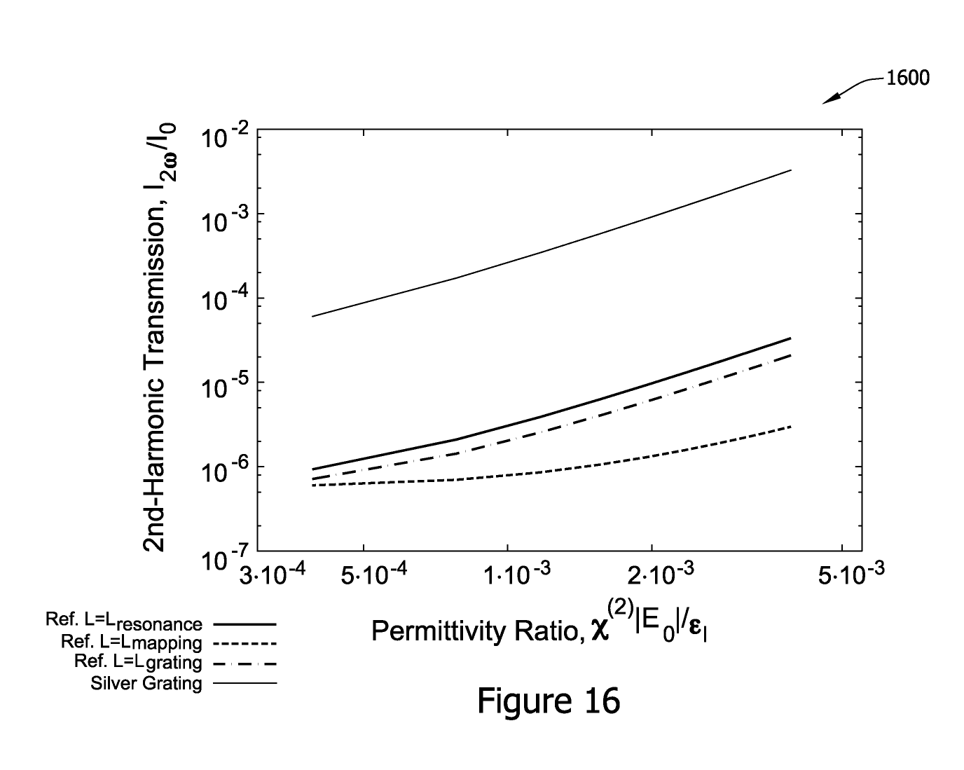

FIG. 16 shows a graph 1600 of the second harmonic generation of the grating with silver and CuCl. At the same field inputs, reference slabs containing CuCl at the three previously proposed thicknesses were also analyzed. Under the low field input conditions, the second harmonic generation in both systems is in their beginning stages, where conversion efficiency is small. Because the conversion to second harmonic generation is linear at low field strength, two orders of magnitude enhancement is evident, even with losses from silver gratings. For materials at longer wavelengths, losses from metal will diminish, where as shorter wavelengths will reduced the effectiveness of metal due to larger field penetration into the metal. Overall, this result demonstrates the enhancement of nonlinear materials and justifies previous assumptions.

The metamaterials described herein (e.g., array 100 shown in FIG. 1, structure 1000 shown in FIG. 10, and cube 1100 shown in FIG. 11), in addition to having an enhanced nonlinearity, are also capable of operating in a low-Q regime. In the low-Q regime, a cavity effect is minimized to yield relatively short intrinsic temporal response times, which may be as short as a few picoseconds.

For example, in one numerical simulation demonstrating second harmonic generation, for an array 100 with a=0.165 μm, d=1.325 μm (d/a=8), and L=11.2 μm, the Q-factor was 180. In another numerical simulation demonstrating third harmonic generation, for an array 100 with a=0.294 μm, d=1.767 μm (d/a=6), and L=2.648 μm, the Q-factor was 38. Further, a quality-factor value for the metal-dielectric grating containing Si (discussed above in relation to FIG. 15) at resonance was 380 (i.e., Q=380).

From numerical simulation, it was also observed that a bistability of the metamaterials described herein may be switched between high and low states within ˜30 optical cycles, which corresponds to a switching time of approximately 1 picosecond. Accordingly, by operating at a low-Q regime, a temporal response of the metamaterials described herein may be as short as a few picoseconds.

Embodiments provide metamaterials having an enhanced nonlinear response to light. The metamaterials are artificially manufactured materials having a nonlinear response to light greater than that typically found in naturally occurring materials. A two-dimensional periodic metal-dielectric array can be mathematically mapped as an effective uniform dielectric slab with enhanced optical nonlinearity. The enhanced nonlinearity is controlled by the geometry of the array. Further, the configuration of the array can be applied to form three-dimensional structures having an enhanced nonlinear response to light. The metamaterials described herein may also operate with a relatively low quality factor to provide a temporal response on the order of a few picoseconds.

The order of execution or performance of the operations in the embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An array comprising:
a metallic film comprising a plurality of slits defined therethrough, said plurality of slits having a width a and a periodicity d; and
a plurality of dielectric elements positioned within said plurality of slits, wherein a relationship is defined between a and d such that said array exhibits an enhanced nonlinear response to light transmitted through said plurality of slits.

2. An array in accordance with claim 1, wherein the plurality of dielectric elements are composed of at least one of a Kerr-type material and a Pockels-type material.

3. An array in accordance with claim 1, wherein said array has a temporal response of approximately 1 picosecond.

4. An array in accordance with claim 1, wherein said plurality of dielectric elements are composed from fused silica.

5. An array in accordance with claim 1, wherein said metallic film comprises a first surface and an opposite second surface, said plurality of dielectric elements extend from said first surface to said second surface within said plurality of slits.

6. An array in accordance with claim 1, wherein said array is configured to amplify a third-order nonlinear coefficient of said plurality of dielectric elements by a factor of
$${( \frac{d}{a} )}^{4}$$
when light is transmitted through said plurality of slits.

7. A structure having an enhanced nonlinear response to light, said structure comprising:
a first metallic plate comprising a plurality of slits defined therethrough;
a second metallic plate comprising a plurality of slits defined therethrough, said second metallic plate substantially parallel to said first metallic plate;
a plurality of dielectric elements positioned within said plurality of slits in said first metallic plate and said second metallic plate; and
a shaft coupling said first metallic plate to said second metallic plate.

8. A structure in accordance with claim 7, wherein said plurality of slits in said first metallic plate and said second metallic plate have a width a and a periodicity d, wherein a relationship is defined between a and d such that said structure exhibits an enhanced nonlinear response to light transmitted through said plurality of slits in said first metallic plate and said second metallic plate.

9. An structure in accordance with claim 8, wherein said plurality of dielectric elements are composed from at least one of a Kerr-type material, a Pockels-type material, and fused silica.

10. A structure in accordance with claim 7, wherein said first metallic plate and said second metallic plate are composed from at least one of gold, silver, and aluminum.

11. A structure in accordance with claim 7, wherein said structure has a temporal response of approximately 1 picosecond.

12. A structure in accordance with claim 7, wherein at least one of said first metallic plate and said second metallic plate comprises a plurality of arms extending from a crossbeam, said plurality of slits defined between adjacent pairs of said plurality of arms.

13. A structure in accordance with claim 7, wherein at least one of said first metallic plate and said second metallic plate comprises a first surface and an opposite second surface, said plurality of dielectric elements extend from said first surface to said second surface within said plurality of slits.

14. A structure in accordance with claim 7, further comprising a third metallic plate comprising a plurality of slits defined therethrough, said dielectric elements positioned within said plurality of slits in said third metallic plate, said third metallic plate coupled to said shaft and oriented substantially orthogonal to said first metallic plate and said second metallic plate.

15. A method of assembling a metamaterial having an enhanced nonlinear response to light, said method comprising:
providing a metallic film having a plurality of slits defined therethrough, the slits having a width a and a periodicity d;
inserting, into each of the plurality of slits, a dielectric element, wherein a relationship is defined between a and d such that the metamaterial exhibits an enhanced nonlinear response to light transmitted through the plurality of slits.

16. A method in accordance with claim 15, wherein providing a metallic film comprises providing a metallic film composed of at least one of silver, gold, and aluminum.

17. A method in accordance with claim 15, wherein providing a metallic film comprises providing a metallic film composed of a material having a greater thickness than a skin depth of the material.

18. A method in accordance with claim 15, wherein inserting a dielectric element comprises inserting a dielectric element composed of at least one of a Kerr-type material and a Pockels-type material.

19. A method in accordance with claim 15, wherein inserting a dielectric element comprises inserting a dielectric element such that the dielectric element extends from a first surface of the metallic film to an opposite second surface of the metallic film.

20. A method in accordance with claim 15, wherein providing a metallic film comprises providing a metallic plate that includes a plurality of metallic arms extending from a crossbeam, the plurality of slits defined between adjacent pairs of the plurality of arms.
